(19) United States
(12) Patent Application Publication
(10) Pub. No.: US 2018/0231851 A1
(43) Pub. Date: Aug. 16, 2018

(54) Array Substrate and Display Device

(71) Applicant: Shenzhen China Star Optoelectronics Technology Co., Ltd., Shenzhen, Guangdong (CN)

(72) Inventor: Liyang An, Shenzhen (CN)

(73) Assignee: Shenzhen China Star Optoelectronics Technology Co., Ltd., Shenzhen, Guangdong (CN)

(21) Appl. No.: 15/513,590

(22) PCT Filed: Feb. 13, 2017
(86) PCT No.: PCT/CN2017/073344

§ 371 Date: Mar. 23, 2017

(30) Foreign Application Priority Data
Jan. 3, 2017 (CN) 201710002321.9

(51) Int. Cl. G02F 1/1362; G02F 1/1343

(52) U.S. Cl. CPC G02F 1/136286; G02F 2001/134354; G02F 1/134309; G02F 1/136213

(57) ABSTRACT

The present disclosure proposes an array substrate and a display device. The array substrate includes gate lines, data lines, and pixel units. Each pixel unit includes a main-pixel zone, a first sub-pixel zone, and a second sub-pixel zone. The voltage levels of the main-pixel zone, the first sub-pixel zone, and the sub-pixel zone are completely different owing to the effect of capacitive coupling. In this way, the present disclosure can solve the problems of image distortion in the conventional VA liquid crystal panel.

### BACKGROUND

### 1. Field of the Disclosure

The present disclosure relates to the field of liquid crystal display, and more particularly, to an array substrate and a display device.

### 2. Description of the Related Art

Flat display devices, such as liquid crystal displays (LCDs) have advantages of high-definition, energy-saving, thin body, wide applied field, and so on, so they are widely applied to various kinds of consumer electronics products, such as cellphones, televisions, personal digital assistants (PDAs), digital cameras, notebook computers, and desk computers, and become the mainstream display devices. Conventionally, backlight LCDs are the mainstream products, including thin film transistor liquid crystal display (TFT-LCD) panels and backlight modules. As for the LCD display panel in the mainstream market, the contrast ratio of the VA liquid crystal panel is much higher than the contrast ratio of other kinds of liquid crystal panels so a vertical alignment (VA) liquid crystal panel can be wide applied to wide size display such as televisions. However, the VA liquid crystal panel adopts vertically rotated liquid crystal while the birefringence of liquid crystal molecules varies to a large degree, resulting in more serious color shift with a large viewing angle. Due to the serious color shift, the brightness of the VA liquid crystal panel varies to a large degree from different viewing angles, which resulting in image distortion.

Images shown on the VA display are always different from different viewing angles based on inside elements of liquid crystal display, which causes normal images in normal display conditions to become abnormal of at a wide viewing angle. Such abnormality is usually color abnormality, which is called color shift at a wide viewing angle. To improve color shift of the VA display at a wide viewing angle, a design as shown in FIG. 2 is adopted. The design is that a display unit is divided into a main-pixel and a sub-pixel. The main-pixel and the sub-pixel are controlled by two thin film transistor (TFT) components independently. The TFTs are controlled by the same gate line. When the gate is turned on, the main-pixel and the sub-pixel are charge through a data line. The voltage level of the main-pixel keeps a signal for the data line. The voltage of the sub-pixel is decided by several parts at the same time, and a formula says:

$${V}_{sub} = {V}_{main} \times \frac{{C}_{x}}{{C}_{stsub} + {C}_{lcsub} + {C}_{x}} + {\int }_{0}^{T} \frac{{I}_{sub} ( t )}{{C}_{stsub} + {C}_{lcsub} + {C}_{x}} dt$$

The voltage of Vsub is controlled orientally by adjusting various Cx values resulting in some difference of voltage between the main-pixel and the sub-pixel. So two alignments of the liquid crystal modules are shown in the same grayscale and compensation for big viewing angles really does the trick to compensate for big viewing angles. However, the improvement effect of the design is restricted since greater color shift still occurs in medial grayscale and low grayscale.

### SUMMARY

An object of the present disclosure is to propose an array substrate and a display device to try to solve problems of the related art. In the related art, VA liquid crystal panel adopts vertically rotated liquid crystal while the birefringence of liquid crystal molecules varies to a large degree, resulting in more serious color shift with a large viewing angle. Due to the serious color shift, the brightness of the VA liquid crystal panel varies to a large degree from different viewing angles, which resulting in image distortion.

According to the present disclosure, an array substrate comprises a plurality of gate lines, a plurality of data lines, and a plurality of pixel units formed by the plurality of gate lines intersecting the plurality of data lines. Each of the plurality of pixel units comprises a main-pixel zone, a first sub-pixel zone, and a second sub-pixel zone. The main-pixel zone, the first sub-pixel zone, and the second sub-pixel zone are horizontally arranged in order.

N is a positive integer. One of the plurality of pixel units is connected to the Nth gate line and the (N+1)th gate line. When the Nth gate line is turned on, the main-pixel zone, the first sub-pixel zone, and the second sub-pixel zone is charged through the data line. When the

(N+1)th gate line is turned on, capacitive coupling happens in the main-pixel zone, first sub-pixel zone, and the second sub-pixel zone so that a voltage level of the main-pixel zone, a voltage level of the first sub-pixel zone, and a voltage level of the second sub-pixel zone differ from one another.

Preferably, the main-pixel zone comprises a first transistor. The first sub-pixel zone comprises a second transistor. The second sub-pixel zone comprises a third transistor; the first transistor comprises a gate, the second transistor comprises a gate, and the third transistor comprises a gate; the three gates all are connected to the Nth gate line only.

Preferably, the second sub-pixel zone further comprises a fourth transistor. A gate of the fourth transistor is connected to the (N+1)th gate line only.

Preferably, sources of the first transistor, the second transistor, and the third transistor are connected to one of the data lines. The first transistor comprises a drain connected to a first liquid crystal capacitor and a first storage capacitor. The second transistor comprises a drain connected to a second liquid crystal capacitor and a second storage capacitor. The third transistor comprises a drain connected to a third liquid crystal capacitor and a third storage capacitor.

Preferably, a second capacitor is arranged between the drain of the first transistor and the drain of the second transistor. A first capacitor is arranged between a drain of the fourth transistor and the drain of the third transistor. A source of the fourth transistor is connected to the drain of the second transistor.

Preferably, when the Nth gate line is turned on, the first liquid crystal capacitor, the first storage capacitor, the second liquid crystal capacitor, the second storage capacitor, the third liquid crystal capacitor, the third storage capacitor, the first capacitor, and the second capacitor are charged through the data line. When the (N+1)th gate line is turned on, capacitive coupling happens among the first capacitor, the second storage capacitor, and the second liquid crystal capacitor, and capacitive coupling also happens among the second capacitor, the first storage capacitor, and the first liquid crystal capacitor so that the voltage level of the main-pixel zone, the voltage level of the first sub-pixel zone, and the voltage level of the second sub-pixel zone differ from one another.

Preferably, the data line which is connected to the first transistor, the second transistor, and the third transistor, is arranged an area between the main-pixel zone and the first sub-pixel zone.

Preferably, the first storage capacitor, the second storage capacitor, and the third storage capacitor are connected to a common electrode.

Preferably, the first liquid crystal capacitor, the second liquid crystal capacitor, and the third liquid crystal capacitor are connected to ground.

According to the present disclosure, a display device comprises an array substrate. The array substrate comprises a plurality of gate lines, a plurality of data lines, and a plurality of pixel units formed by the plurality of gate lines intersecting the plurality of data lines. Each of the plurality of pixel units comprises a main-pixel zone, a first sub-pixel zone, and a second sub-pixel zone. The main-pixel zone, the first sub-pixel zone, and the second sub-pixel zone are horizontally arranged in order.

N is a positive integer. One of the plurality of pixel units is connected to the Nth gate line and the (N+1)th gate line. When the Nth gate line is turned on, the main-pixel zone, the first sub-pixel zone, and the second sub-pixel zone is charged through the data line. When the (N+1)th gate line is turned on, capacitive coupling happens in the main-pixel zone, first sub-pixel zone, and the second sub-pixel zone so that a voltage level of the main-pixel zone, a voltage level of the first sub-pixel zone, and a voltage level of the second sub-pixel zone differ from one another.

Preferably, the main-pixel zone comprises a first transistor; the first sub-pixel zone comprises a second transistor. The second sub-pixel zone comprises a third transistor; the first transistor comprises a gate, the second transistor comprises a gate, and the third transistor comprises a gate; the three gates all are connected to the Nth gate line only.

Preferably, the second sub-pixel zone further comprises a fourth transistor; a gate of the fourth transistor is connected to the (N+1)th gate line only.

Preferably, sources of the first transistor, the second transistor, and the third transistor are connected to one of the data lines. The first transistor comprises a drain connected to a first liquid crystal capacitor and a first storage capacitor. The second transistor comprises a drain connected to a second liquid crystal capacitor and a second storage capacitor; the third transistor comprises a drain connected to a third liquid crystal capacitor and a third storage capacitor.

Preferably, a second capacitor is arranged between the drain of the first transistor and the drain of the second transistor. A first capacitor is arranged between a drain of the fourth transistor and the drain of the third transistor. A source of the fourth transistor is connected to the drain of the second transistor.

Preferably, when the Nth gate line is turned on, the first liquid crystal capacitor, the first storage capacitor, the second liquid crystal capacitor, the second storage capacitor, the third liquid crystal capacitor, the third storage capacitor, the first storage capacitor, and the second capacitor are charged through the data line. When the (N+1)th gate line is turned on, capacitive coupling happens among the first capacitor, the second storage capacitor, and the second liquid crystal capacitor, and capacitive coupling also happens among the second capacitor, the first storage capacitor, and the first liquid crystal capacitor so that the voltage level of the main-pixel zone, the voltage level of the first sub-pixel zone, and the voltage level of the second sub-pixel zone differ from one another.

Preferably, the data line which is connected to the first transistor, the second transistor, and the third transistor, is arranged an area between the main-pixel zone and the first sub-pixel zone.

Preferably, the first storage capacitor, the second storage capacitor, and the third storage capacitor are connected to a common electrode.

Preferably, the first liquid crystal capacitor, the second liquid crystal capacitor, and the third liquid crystal capacitor are connected to ground.

In the present disclosure, a display device having an array substrate is provided. A pixel unit of the array substrate is divided into a main-pixel zone, a first sub-pixel zone, and a second sub-pixel zone. The voltage levels of the main-pixel zone, the first sub-pixel zone, and the sub-pixel zone are completely different owing to the effect of capacitive coupling. In this way, the present disclosure can solve the problems of the related art the VA liquid crystal panel adopting vertically rotated liquid crystal, which resulting in distinct birefringence of liquid crystal molecules, more serious color shift with a large viewing angle, a wide range of brightness of the VA liquid crystal panel from different viewing angles, and image distortion.

### BRIEF DESCRIPTION OF THE DRAWINGS

FIG. 1 illustrates a pixel unit of an array substrate according to a preferred embodiment of the present disclosure.

FIG. 2 illustrates a conventional pixel unit of an array substrate.

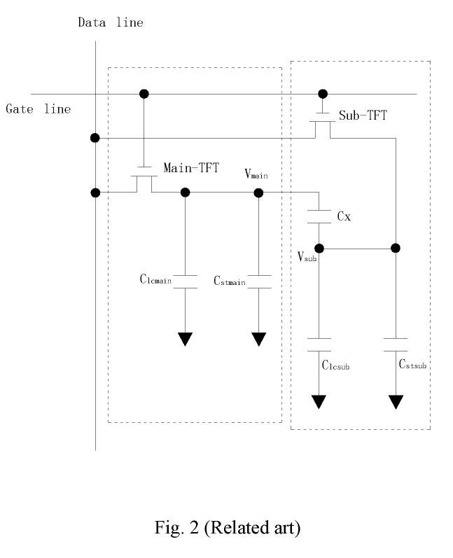

### DETAILED DESCRIPTION OF THE PREFERRED EMBODIMENTS

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. In the drawings, the components having similar structures are denoted by the same numerals.

### Embodiment 1

The fundamental principle of the present disclosure is as follows. Each pixel is divided into three parts. The three parts are insulated from one another. One of the parts is set as main-pixel zone 100, and the others are set as first sub-pixel zone 200 and second sub-pixel zone 300. A voltage is imposed on the main-pixel zone 100, the first sub-pixel zone 200, and the second sub-pixel zone 300, respectively, and the voltage is the same. After capacitive coupling works on the three pixel zones, which are insulated from one another, the voltage imposed on the three pixel zones is different. Further, a deflective angle of the liquid crystal in each of the pixel zones is different from one another, which makes it possible to compensate for the liquid crystal display panel with a large viewing angle because of color shift.

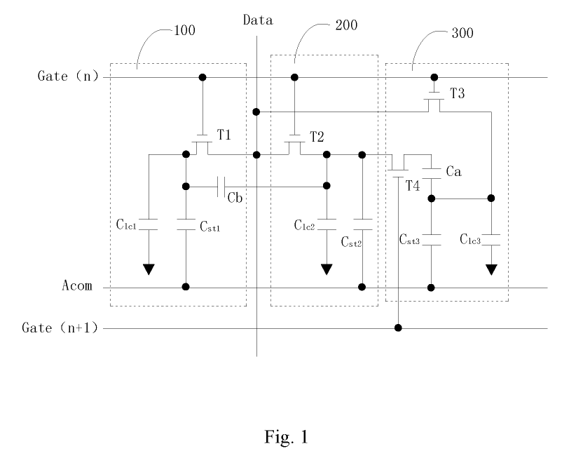

Please refer to FIG. 1 illustrating a schematic diagram of a pixel unit of the array substrate according one preferred embodiment of the present disclosure. The array substrate includes components as follows.

The array substrate includes a plurality of gate lines Gate, a plurality of data lines Data, and a plurality of pixel units formed by the plurality of gate lines Gate intersecting the plurality of data lines Data. Each of the plurality of pixel units includes a main-pixel zone 100, a first sub-pixel zone 200, and a second sub-pixel zone 300. The main-pixel zone 100, the first sub-pixel zone 200, and the second sub-pixel zone 300 are horizontally arranged in order.

N is a positive integer. One of the pixel units is connected to the Nth gate line Gate and the (N+1)th gate line Gate. When the Nth gate line Gate is turned on, the main-pixel zone 100, the first sub-pixel zone 200, and the second sub-pixel zone 300 are charged through the data line Data. When the (N+1)th gate line Gate is turned on, capacitive coupling happens in the main-pixel zone 100, the first sub-pixel zone 200, and the second sub-pixel zone 300. In this way, the voltage level of the main-pixel zone 100, the voltage level of the first sub-pixel zone 200, and the voltage level of the second sub-pixel zone 300 differ from one another.

The structure of each of the plurality of pixel units is described as follows.

The main-pixel zone 100 includes a first transistor T1. The first sub-pixel zone 200 includes a second transistor T2. The second sub-pixel zone 300 includes a third transistor T3. The first transistor T1 includes a gate, the second transistor T2 includes a gate, and the third transistor T3 includes a gate, and the three gates all are connected to an Nth gate line Gate only.

Moreover, the second sub-pixel zone 300 further includes a fourth transistor T4. The fourth transistor T4 includes a gate, which is connected to an (N+1)th gate line only.

In this embodiment, the first transistor T1, the second transistor T2, and the third transistor T3 all include a source. The three sources are all connected to the same data line Data. The first transistor T1 includes a drain, which is connected to a first liquid crystal capacitor C_{lc1} and a first storage capacitor Cₛₜ₁. The second transistor T2 includes a drain, which is connected to a second liquid crystal capacitor C_{lc2} and a second storage capacitor Cₛₜ₂. The third transistor T3 includes a drain, which is connected to a third liquid crystal capacitor C_{lc3} and a third storage capacitor Cₛₜ₃.

In addition, a second capacitor Cb is arranged between the drain of the first transistor T1 and the drain of the second transistor T2. A first capacitor Ca is arranged between the drain of the fourth transistor T4 and the drain of the third transistor T3. The source of the fourth transistor T4 is connected to the drain of the second transistor T2.

In this embodiment, the data line which is connected to the first transistor T1, the second transistor T2, and the third transistor T3, is arranged between the main-pixel zone 100 and the first sub-pixel zone 200. One terminal of the first storage capacitor Cₛₜ₁, one terminal of the second storage capacitor Cₛₜ₂, and one terminal of the third storage capacitor Cₛₜ₃ are all connected to a common electrode. One terminal of the first liquid crystal capacitor C_{lc1}, one terminal of the second liquid crystal capacitor C_{lc2}, and one terminal of the third liquid crystal capacitor C_{lc3} are all grounded.

The operating principle is as follows:

When the Nth gate line Gate is turned on, the first liquid crystal capacitor C_{lc1}, the first storage capacitor Cₛₜ₁, the second liquid crystal capacitor C_{lc2}, the second storage capacitor Cₛₜ₂, the third liquid crystal capacitor C_{lc3}, the third storage capacitor Cₛₜ₃, the first capacitor Ca, and the second capacitor Cb are charged through the data line Data. Meanwhile, some electric charge is gathered at a capacitance plate (i.e. lower end plate) arranged on one terminal where the first capacitor Ca and the third transistor T3 are connected. Some electric charge is gathered at a capacitance plate arranged on each of the terminals of the second capacitor Cb.

When the (N+1)th gate line Gate is turned on and the Nth gate line Gate is turned off, the effect of capacitive coupling works among the first capacitor Ca, the second storage capacitor C_{lc2}, and the second liquid crystal capacitor C_{lc2}. In other words, the voltage level of an upper end plate of the first capacitor Ca is lower, both of the voltage level of an upper end plate of the second liquid crystal capacitor C_{lc2} and the voltage level of an upper end plate of the second storage capacitor Cₛₜ₂ are higher. The upper end plate of the second liquid crystal capacitor C_{lc2} and the upper end plate of the second storage capacitor Cₛₜ₂ are connected to the drain of the second transistor T2. Besides, the electric charge at the upper end plates of the second liquid crystal capacitor C_{lc2} and the second storage capacitor Cₛₜ₂ are transferred to the upper end plate of the first capacitor Ca. As a result, the total voltage level of the first sub-pixel zone 200 lowers and the total voltage level of the second sub-pixel zone 300 rises.

The effect of capacitive coupling works among the second capacitor Cb, the first storage capacitor Cₛₜ₁, and the first liquid crystal capacitor C_{lc1}. In other words, some electric charge at the upper end plate of the second storage capacitor Cₛₜ₂ and the second liquid crystal capacitor C_{lc2} is transferred to the first capacitor Ca. After the electric charge is transferred, the voltage levels of the second storage capacitor Cₛₜ₂ and the second liquid crystal capacitor Cb are lowered. At this time, some electric charge at the second capacitor Cb is transferred to the second storage capacitor Cₛₜ₂ and the second liquid crystal capacitor C_{lc2}, which causes the voltage level of the second capacitor Cb to lower and further causes the voltage level of the main-pixel zone 100 to lower.

In sum, the voltage levels of the main-pixel zone 100, the first sub-pixel zone 200, and the second sub-pixel zone 300 are completely different.

The present disclosure proposes an array substrate. A pixel unit of the array substrate is divided into a main-pixel zone, a first sub-pixel zone, and a second sub-pixel zone. The voltage levels of the main-pixel zone, the first sub-pixel zone, and the sub-pixel zone are completely different owing to the effect of capacitive coupling. In this way, the present disclosure can solve the problems of the related art the VA liquid crystal panel adopting vertically rotated liquid crystal, which resulting in distinct birefringence of liquid crystal molecules, more serious color shift with a large viewing angle, a wide range of brightness of the VA liquid crystal panel from different viewing angles, and image distortion.

### Embodiment 2

A display device proposed by a second preferred embodiment includes an array substrate introduced in the first preferred embodiment. The array substrate is elaborated in the first embodiment and is not detailed here.

The present disclosure proposes a display device having an array substrate. A pixel unit of the array substrate is divided into a main-pixel zone, a first sub-pixel zone, and a second sub-pixel zone. The voltage levels of the main-pixel zone, the first sub-pixel zone, and the sub-pixel zone are completely different owing to the effect of capacitive coupling. In this way, the present disclosure can solve the problems of the related art the VA liquid crystal panel adopting vertically rotated liquid crystal, which resulting in distinct birefringence of liquid crystal molecules, more serious color shift with a large viewing angle, a wide range of brightness of the VA liquid crystal panel from different viewing angles, and image distortion.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should be considered to belong to the protection scope of the present disclosure.

What is claimed is:

1. An array substrate, comprising: a plurality of gate lines, a plurality of data lines, and a plurality of pixel units formed by the plurality of gate lines intersecting the plurality of data lines; each of the plurality of pixel units comprising a main-pixel zone, a first sub-pixel zone, and a second sub-pixel zone; the main-pixel zone, the first sub-pixel zone, and the second sub-pixel zone being horizontally arranged in order; wherein
N is a positive integer; one of the plurality of pixel units is connected to the Nth gate line and the (N+1)th gate line; when the Nth gate line is turned on, the main-pixel zone, the first sub-pixel zone, and the second sub-pixel zone is charged through the data line; when the (N+1)th gate line is turned on, capacitive coupling happens in the main-pixel zone, first sub-pixel zone, and the second sub-pixel zone so that a voltage level of the main-pixel zone, a voltage level of the first sub-pixel zone, and a voltage level of the second sub-pixel zone differ from one another.

2. The array substrate of claim 1, wherein the main-pixel zone comprises a first transistor; the first sub-pixel zone comprises a second transistor; the second sub-pixel zone comprises a third transistor; the first transistor comprises a gate, the second transistor comprises a gate, and the third transistor comprises a gate; the three gates all are connected to the Nth gate line only.

3. The array substrate of claim 2, wherein the second sub-pixel zone further comprises a fourth transistor; a gate of the fourth transistor is connected to the (N+1)th gate line only.

4. The array substrate of claim 3, wherein sources of the first transistor, the second transistor, and the third transistor are connected to one of the data lines; the first transistor comprises a drain connected to a first liquid crystal capacitor and a first storage capacitor; the second transistor comprises a drain connected to a second liquid crystal capacitor and a second storage capacitor; the third transistor comprises a drain connected to a third liquid crystal capacitor and a third storage capacitor.

5. The array substrate of claim 3, wherein a second capacitor is arranged between the drain of the first transistor and the drain of the second transistor; a first capacitor is arranged between a drain of the fourth transistor and the drain of the third transistor; a source of the fourth transistor is connected to the drain of the second transistor.

6. The array substrate of claim 5, wherein when the Nth gate line is turned on, the first liquid crystal capacitor, the first storage capacitor, the second liquid crystal capacitor, the second storage capacitor, the third liquid crystal capacitor, the third storage capacitor, the first capacitor, and the second capacitor are charged through the data line; when the (N+1)th gate line is turned on, capacitive coupling happens among the first capacitor, the second storage capacitor, and the second liquid crystal capacitor, capacitive coupling also happens among the second capacitor, the first storage capacitor, and the first liquid crystal capacitor, so that the voltage level of the main-pixel zone, the voltage level of the first sub-pixel zone, and the voltage level of the second sub-pixel zone differ from one another.

7. The array substrate of claim 4, wherein the data line which is connected to the first transistor, the second transistor, and the third transistor, is arranged between the main-pixel zone and the first sub-pixel zone.

8. The array substrate of claim 4, wherein the first storage capacitor, the second storage capacitor and the third storage capacitor are connected to a common electrode.

9. The array substrate of claim 4, wherein the first liquid crystal capacitor, the second liquid crystal capacitor and the third liquid crystal capacitor are connected to ground.

10. A display device, comprising an array substrate, the array substrate comprising:
a plurality of gate lines, a plurality of data lines, and a plurality of pixel units formed by the plurality of gate lines intersecting the plurality of data lines; each of the plurality of pixel units comprising a main-pixel zone, a first sub-pixel zone, and a second sub-pixel zone; the main-pixel zone, the first sub-pixel zone, and the second sub-pixel zone being horizontally arranged in order; wherein
N is a positive integer; one of the plurality of pixel units is connected to the Nth gate line and the (N+1)th gate line; when the Nth gate line is turned on, the main-pixel zone, the first sub-pixel zone, and the second sub-pixel zone is charged through the data line; when the (N+1)th gate line is turned on, capacitive coupling happens in the main-pixel zone, first sub-pixel zone, and the second sub-pixel zone so that a voltage level of the main-pixel zone, a voltage level of the first sub-pixel zone, and a voltage level of the second sub-pixel zone differ from one another.

11. The display device of claim 10, wherein the main-pixel zone comprises a first transistor; the first sub-pixel zone comprises a second transistor; the second sub-pixel zone comprises a third transistor; the first transistor comprises a gate, the second transistor comprises a gate, and the third transistor comprises a gate; the three gates all are connected to the Nth gate line only.

12. The display device of claim 11, wherein the second sub-pixel zone further comprises a fourth transistor; a gate of the fourth transistor is connected to the (N+1)th gate line only.

13. The display device of claim 12, wherein sources of the first transistor, the second transistor, and the third transistor are connected to one of the data lines; the first transistor comprises a drain connected to a first liquid crystal capacitor and a first storage capacitor; the second transistor comprises a drain connected to a second liquid crystal capacitor and a second storage capacitor; the third transistor comprises a drain connected to a third liquid crystal capacitor and a third storage capacitor.

14. The display device of claim 12, wherein a second capacitor is arranged between the drain of the first transistor and the drain of the second transistor; a first capacitor is arranged between a drain of the fourth transistor and the drain of the third transistor; a source of the fourth transistor is connected to the drain of the second transistor.

15. The display device of claim 14, wherein when the Nth gate line is turned on, the first liquid crystal capacitor, the first storage capacitor, the second liquid crystal capacitor, the second storage capacitor, the third liquid crystal capacitor, the third storage capacitor, the first capacitor, and the second capacitor are charged through the data line; when the (N+1)th gate line is turned on, capacitive coupling happens among the first capacitor, the second storage capacitor, and the second liquid crystal capacitor, capacitive coupling also happens among the second capacitor, the first storage capacitor, and the first liquid crystal capacitor so that the voltage level of the main-pixel zone, the voltage level of the first sub-pixel zone, and the voltage level of the second sub-pixel zone differ from one another.

16. The display device of claim 13, wherein the data line which is connected to the first transistor, the second transistor, and the third transistor, is arranged an area between the main-pixel zone and the first sub-pixel zone.

17. The display device of claim 13, wherein the first storage capacitor, the second storage capacitor, and the third storage capacitor are connected to a common electrode.

18. The display device of claim 13, wherein the first liquid crystal capacitor, the second liquid crystal capacitor, and the third liquid crystal capacitor are connected to ground.
